(19) United States
(12) Patent Application Publication
(10) Pub. No.: US 2004/0153325 A1
(43) Pub. Date: Aug. 5, 2004

(54) Service ordering system and method

(75) Inventor: Paul Magee, West Pennant Hills (AU)

Correspondence Address: DARBY & DARBY P.C., P. O. BOX 5257, NEW YORK, NY, 10150-5257, US

(73) Assignee: VeCommerce Limited, Lane Cove (AU)

(21) Appl. No.: 10/356,332

(22) Filed: Jan. 31, 2003

(51) Int. Cl. G10L 11/00

(52) U.S. Cl. 704/277

(57) ABSTRACT

The present invention relates to the utilisation of voice recognition systems and, in particular, discloses a system for ordering a service such as a taxi or the like.

### FIELD OF THE INVENTION

The present invention relates to the utilisation of voice recognition systems and, in particular, discloses a system for ordering a service such as a taxi or the like.

### BACKGROUND OF THE INVENTION

The traditional service for ordering a taxi normally comprises a manual system whereby a person wishing to order a taxi calls a predetermined phone number and the call is answered by a series of operators who take down the details of the taxi request. The requests are then normally forwarded to radio operators who dispatch the request to awaiting taxis which are then directed to the telephone caller's requisite address.

Unfortunately, such an arrangement has a number of significant drawbacks. Firstly, a series of trained operators is required to answer the telephone and dispatch requests for taxis. Further, demands may fluctuate widely, hence making it difficult to maintain optimal staffing ratios. This can often result in excessive waiting times for customers during peak periods. This can often result in a loss of trade and poor customer service when customers are kept waiting for long periods of time. The same problem may exist with other service delivery scenarios such as home delivered food and courier services.

### SUMMARY OF THE INVENTION

It is an object of the present invention to provide for an effective alternative form of service ordering system and method utilising voice recognition technologies.

In accordance with a first aspect of the present invention, there is provided a system interconnected with the public switched telephone network for providing for the ordering of taxis using natural language voice recognition, the system comprising: a database of correlation data correlating a telephone identification number with an address; caller identification system for identifying the telephone number associated with a caller; a voice prompting unit for prompting a caller with the address registered in the database associated with the telephone number of the caller and whether the caller requires an immediate taxi service; a voice recognition unit for recognising if the caller wishes an immediate taxi service at the address; communications unit interconnected to a dispatch unit for dispatching taxi requests wherein the voice recognition unit determines that a caller wishes an immediate taxi at the address.

The caller identification system preferably can include a call line identifier that determines a call line associated with the caller or a voice recognition system for recognising a telephone number read to it by a caller. Preferably, the system also includes an address recording means for recording the address associated with a caller telephone number for storage in the database for use with subsequent service request. The address recording means can comprise a human operator.

The system further can comprise transfer means for transferring calls via a PABX or the like to one of a series of human operators upon predetermined conditions occurring in the interaction of the system with a caller.

In accordance with a further aspect of the present invention, there is provided a method of utilising a natural language speech recognition to dispatch a taxi to an address. the method comprising: (a) creating a database of correlations between caller telephone numbers and caller addresses; (b) determining a caller's telephone number upon calling; (c) retrieving a corresponding caller's address from the database for the caller's telephone number; (d) utilising a text to speech system or recorded prompt system to convert the caller's address to a corresponding audio address; (e) reading the address back to the caller in addition to a confirmation request and a ready now request; (f) determining if the caller confirms the confirmation request and ready now request; (g) upon detecting a confirmation by the caller, dispatching a taxi service to the caller address.

In accordance with a further aspect of the present invention, there is provided a method of enhancing the capability of a natural language speech recognition to dispatch a taxi to caller's addresses, the method comprising the step of: (a) creating a database of correlations between caller telephone numbers and caller addresses; (b) determining a caller's telephone number upon calling; (c) determining if a caller's telephone number is within the database; (d) if the caller's telephone number does not exist in the database: (i) interrogating the caller for a caller address associated with the caller's telephone number; (ii) determining a correlation in the database between the caller telephone number and caller address for future use.

In accordance with a further aspect of the present invention, there is provided a method of introducing voice recognition into a public switched telephone network taxi ordering system, the method comprising the steps of: (a) introducing an initial system which provides for immediate address recognition upon call line identification and a system voice proposal to deliver a taxi at a corresponding address upon call line identification; (b) introducing a subsequent system including voice interrogation of taxi requirements of callers.

The system is preferably able to look up a database based on call line identification, extracts a taxi delivery address, asks the caller whether the taxi delivery address can be correct and whether the caller can be ready now and dispatches a taxi upon receiving a readiness and address confirmation. The system introduced in accordance with the step (b) preferably can include a voice recognition of a caller's telephone number. The system introduced in accordance with the step (b) also preferably can include catering for at least one of differing taxi types, number of people, number of vehicles, pickup day, pickup time and destination address.

### BRIEF DESCRIPTION OF THE DRAWINGS

Preferred embodiments of the present invention will now be described with reference to the accompanying drawings in which:

FIG. 1 illustrates schematically a hardware layout of the preferred embodiment;

FIG. 2 illustrates schematically the software control flow of the preferred embodiment;

FIG. 3 illustrates a simple call flow control for an initial embodiment; and

FIG. 4 illustrates a more complex call flow control of an alternative embodiment.

### DESCRIPTION OF PREFERRED AND OTHER EMBODIMENTS

In the preferred embodiment, there is provided a taxi ordering system which utilises voice recognition technologies to take a taxi order in an automated manner so as to provide for a rapid taxi ordering service especially where peak demands may otherwise result in service deterioration.

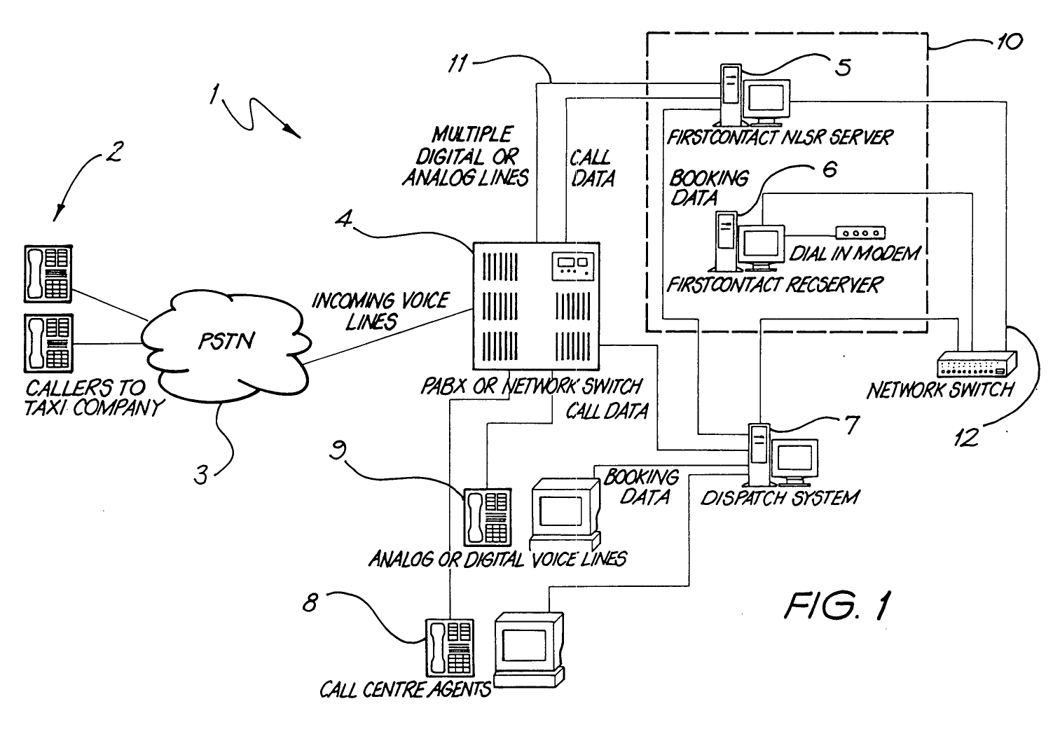

Turning initially to FIG. 1, there is illustrated schematically the hardware arrangement of the preferred embodiment. In the preferred embodiment a series of callers 2 are assumed to be interconnected to the public switched telephone network 3 as is normally the case. The callers 2 are located in various geographically locations. The callers call into the taxi company PABX 4. Initially the call is routed to the NLSR Taxi Booking system 10 which includes a First Contact Server 5 and Recognition Server 6. The First Contact server 5 answers the call and interacts with the caller through natural spoken language.

Where available, the Caller Line ID is recorded and utilised to extract information from a taxi company database stored within taxi company dispatch system 7 so as to obtain the callers details. Alternatively the callers phone number can be obtained by the system requesting the caller's telephone number to be spoken to the Taxi booking system over the telephone.

Various conversational interactions are then undertaken with the caller by the First Contact Server 5. The interactions provide information as to when the caller would like to be picked up, what type of vehicle is required and the number of passengers required.

Once the requisite details have been obtained, the information is read back to the caller utilising either a Text or Speech engine or prerecorded prompts to audibly provide the opportunity for confirmation of the data in the database record to the client.

On acceptance of the booking details by the caller, a message is forwarded to the dispatch system 7 for booking the taxi. The system then informs the caller that a Taxi has been booked and provides a booking reference number and the dispatch system is utilised to dispatch a taxi to fetch the caller/passengers. It would be understood that this can be done in many ways depending upon what legacy taxi dispatch system is utilised. For example, the message could be forwarded to a series of human radio dispatches or to an automated dispatch system.

The caller, as most points of its interaction with the First Contact Server, can be transferred to a human operator 8, 9 via the PABX 4.

The First Contact Server 5 answers the calls that are directed to it and manages the flow of the call including a return transfer to the switch of PSTN network, when callers have to be transferred to a human operator 8, 9. The First Contact Server also contains the Taxi Ordering System call flow with the associated prompting to the user. The call flow contains the business logic on the processing of the dialog of the calls.

The interface between the Taxi Ordering system call flow and the Recognition Server is made through the Recognition Client. The Recognition Server 6 is responsible for analysing speech data provided by the First Contact Server and returning the information that is contained in the Natural Language that the caller speaks. In one embodiment, the Recognition Server is installed on a separate machine due to the speed required to analyse and interpret speech from the caller. The call processing grammars resides on this machine. The grammars interpret the data and look for grammar matches in the recognised utterances.

The First Contact server 5 can be connected to the PABX or PSTN via a number of different telephony interface 11 such as Analogue, T1 or E1 interface protocols with inbound and outbound channels enabled. The telephone interface is responsible for sending and receiving all information to and from the PABX. As such, where available, it includes the Called Number such as DNIS and Calling Line Identification (CLI).

The First Contact server 5 is connected 12 to the Taxi and Dispatch System 7 via TCP/IP protocols over a standard data network such as Ethernet 10/100 Mbps LAN. The server 5 includes a Host Interface which is responsible for sending and receiving all information to and from the dispatch system database stored on dispatch system computer 7 This can include CLI, template information and the booking details.

The human operators managing phones 8,9 are required for handling situations such as where the caller rings back within a set time period, say 20 minutes, enquiries, speech miss-recognition or specific requests by a caller.

Taxi-Ordering System—General System Behavior

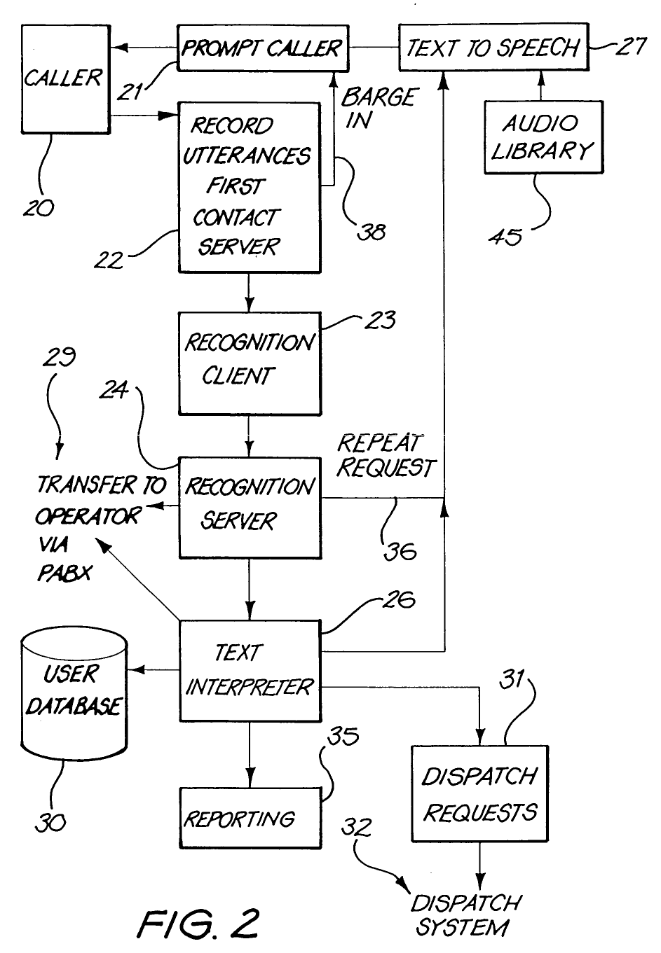

FIG. 2 illustrates the general flow of control in the preferred embodiment. A caller 20 is prompted by a prompt caller module 21 which prompts the user with various questions. The responses are recorded by a record utterance module 22 which is located on the first contact server. The recording of utterance can include a barge in facility whereby when an utterance is recorded, the prompt caller module 21 thereby suppresses the prompting. A recognition client 23 is responsible for forwarding the utterance to the recognition server 24. The recognition server 24 attempts to recognize the utterance and convert it in to a textual format. Any recognised textual response is referred to the textual interpreter. Where a response is unrecognised, the recognition server can forward a repeat request such as “sorry I didn't understand that etc” the repeat request can be forwarded to a text to speech processor module 27 which includes a series of prerecorded questions in addition to text to voice generation mechanisms. The output of the text to speech module 27 is forwarded to the prompt caller module 21 for forwarding to the caller.

The recognition server 24, when there is a continuing problem with the recognition of a caller's voice, can transfer the caller to an operator via the PABX 29. Similarly the text interpreter 26, when it experience problems with the recognised text can also forward the caller to the operator via the PABX.

The text interpreter module 26 also interacts with a user database 30 and formulates dispatches for a dispatch request module 31 which forwards the dispatches to the dispatch system 32. The text interpreter 26 also provides reporting facilities 35.

The First Contact Server 5 initially captures the utterances. The utterances are sent to the Recognition Server 24 via the Recognition Client 23. The Recognition Server 24 initially processes the utterance to determine whether an utterance has been heard. If an utterance has not been heard, the prompt, “Sorry, I didn't hear you” or similar prompt followed by the appropriate data request prompt is relayed back 36 to the caller 21 via the text to speech processor 27.

If an utterance is heard, the Recognition Server 24 attempts to recognised the spoken text and forward the information to the text interpreter 26 for appropriate action. If the utterance is not recognised, a prompt: “Sorry, I didn't understand that” followed by context sensitive help as to what the caller may say to the system at that point is relayed 36 back to the text to speech engine 27 and the appropriate data request prompt is then emitted. In either case, after a predetermined maximum error count is reached, the caller is automatically transferred 29 to the operator queue on the PABX with the CLI and called number.

A barge in facility can be provided 38 whereby the caller responding with an early answer suspends the current question prompting. The barge in facility can be available at all points in the call flow except under the following circumstances if required: when the welcome prompt is played; when the pick up address is being read out by the Taxi Ordering System; when the booking details are being read back, with the exception of “no” and a correction. Context sensitive help is preferably made available at every stage of the call flow, and error messages are structured so as to guide the caller as to what are valid answers at each stage.

The Prompt caller module 21 can rely on a number of sources from prompts. These are forwarded by Text-to-Speech engine 27. The prompts can be on two forms. Firstly, there are prompts that can be professionally recorded and stored in an audio library and integrated into the call flow. Dynamic information, such as the pickup address, will be spoken by the system using synthesized voice technology known as Text-to-Speech (TTS).

In the preferred embodiment, a number of voice recognition systems, text to speech systems or prerecorded speech systems can be utilised depending upon availability and legacy requirements.

Suppliers of suitable speech recognition systems include the companies: Nuance, Speechworks, Phillips, IBM, Vocalis and Fluency.

Suppliers of suitable Text to Speech and Voice Recorded Systems include Nuance, Speechworks, Rhetorical, ATT and Aculab.

Suppliers of suitable Dispatch Systems include Raywood, Motorola and Nokia.

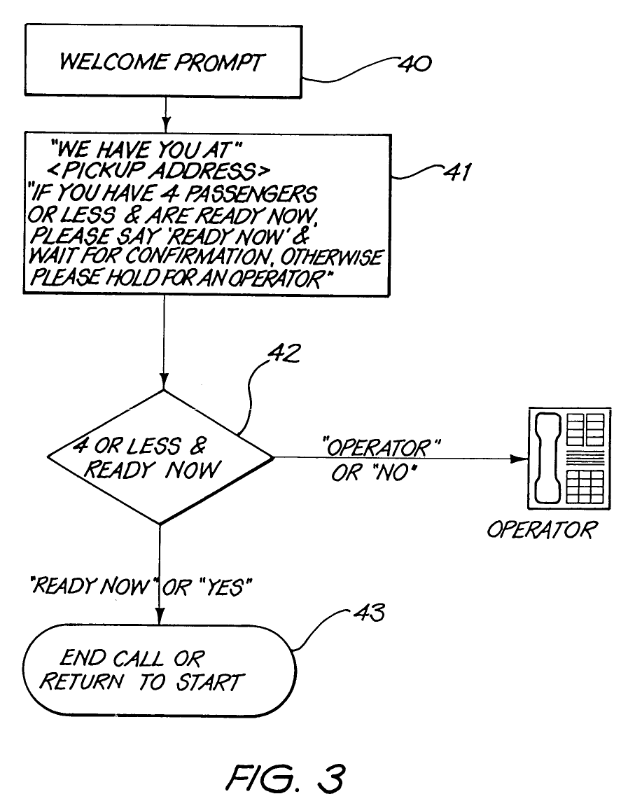

FIG. 3 illustrates the call flow of a simple initial system implementation. This example is suitable for an initial ‘bootstrap’ application, enabling simplified call processing to take place. In this example, an initial welcoming prompt 41 is provided. The system then utilises the caller ID to look up a previously created database entry to locate the user at a particular address. The prompt 41 is then played and the system listens for the response 42 of Yes, Ready Now, Operator or No. Upon detecting a Ready Now or Yes, the system sends a dispatch request to the dispatch system to dispatch a taxi. Upon receiving an “Operator” or “No”, the system transfers the user to an operator via the PABX. The operator is able to book a taxi and also take future address details for the particular caller ID for storage in the database 30 for future use.

In the simple embodiment discussed with reference to FIG. 3, the Taxi Ordering System Call Flow is able to obtain the following information from the caller using conversational speech.

Pick Up Address Confirmation (Yes or No)

In the simple system, the Taxi Ordering System reads the pick up address from the information previously stored in the User database 30. This information has been previously recorded for the user. This is then forward to the Text to Speech unit 27 for reading back and confirmation by the user. The Pickup address will consist of two fields namely, street address and suburb. The address data is parsed through a language parser to ensure correct pronunciation of the database records.

4 or Less People Who are Ready Now (Yes or No)

The Taxi Ordering System asks the caller whether there are four or less passengers who are ready to be picked up immediately. The caller will be transferred to the operator queue on the PABX, with the CLI and called number, if they say “No” thereby indicating there are more than 4 passengers, or they are not ready now. The caller is requested to wait for confirmation of the booking before hanging up.

By using the simplified call flow, there is provided an initial simple system for substantially improving processing delays in taxi ordering, especially during peak periods, as it allows for clients with simple requests to be dealt with in an expeditious manner.

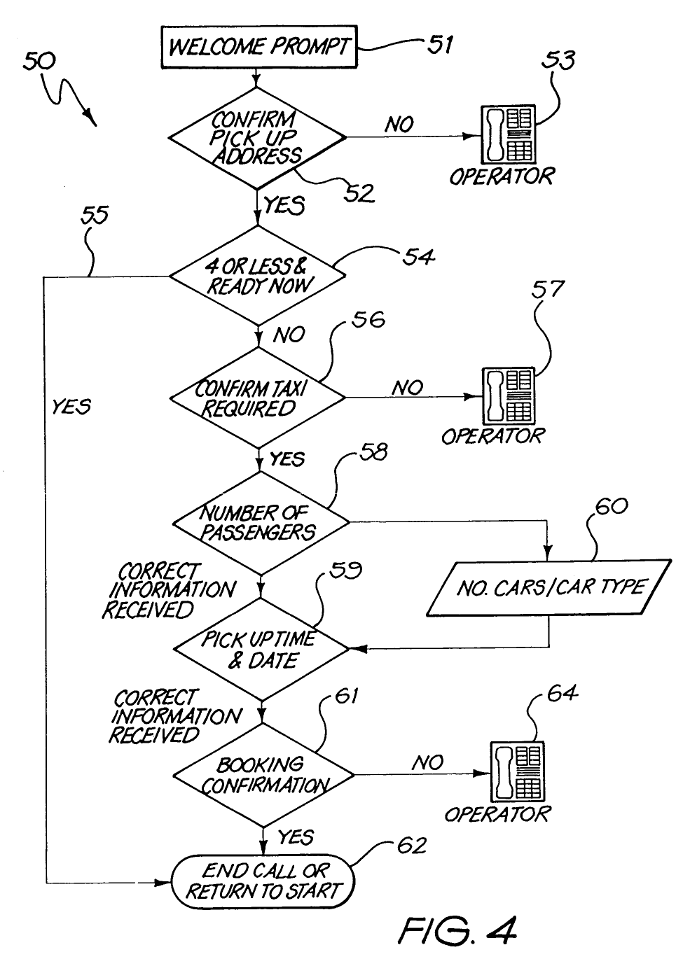

FIG. 4 illustrates a more complex form of flow control processing which can be implemented subsequent to successful rollout of the initial system. In this example, the initial pick up address is first confirmed with the user 52. If the address is wrong, the call is immediately forwarded to the operator 53 for booking a taxi and taking future address details for the particular caller ID for storage in the database for future use. Otherwise, the system prompts for whether four or less passengers are ready to depart. If so, the system can dispatch a taxi 55. Otherwise, the system firstly prompts the user 56 to confirm that a taxi is required. If the answer is no or indeterminate, the system transfers the user to the operator 57. Otherwise the system next prompts 58 the user for the number of passengers. Once the number of passengers is confirmed, a car or car type determination is made 60 using the table set out below. Next a pick up time and date 59 is determined.

TABLE 1
Car/Vehicle Types

| No. | | Number of Passengers | | | | | | | |
|---|---|---|---|---|---|---|---|---|---|
| Cars | Car Type | 1-4 | 5 | 6 | 7 | 8 | 9 | 10 | 11 |
| 1 | Any/Taxi | ✓ | | | | | | | |
| 1 | 4 Seater Sedan/Taxi | ✓ | | | | | | | |
| 1 | 4 Seater Station | ✓ | | | | | | | |
| | Wagon/Taxi | | | | | | | | |
| 1 | 5 Seater/Taxi | | ✓ | | | | | | |
| 1 | 7 Seater Van/Taxi | | | ✓ | ✓ | | | | |
| 1 | 10 Seater Van/Taxi | | | | | ✓ | ✓ | ✓ | |
| 1 | 11 Seater Van/Taxi | | | | | | | | ✓ |
| 2 | 4 Seater Sedan/Taxi | | | ✓ | ✓ | ✓ | | | |
| 2 | 4 Seater Station | | | ✓ | ✓ | ✓ | | | |
| | Wagon/Taxi | | | | | | | | |
| 2 | 5 Seater/Taxi | | | | | | ✓ | ✓ | |

The details of the booking are then confirmed 61 by replaying them back to the caller with a request for a yes or no answer on correctness. If the details are incorrect, the caller is forward to the operator 64. Otherwise, the booking is dispatched.

In the more complex call flow, as shown in FIG. 4, the system is ideally able to:

Obtain the callers telephone number with direct prompting

Obtain the number of passengers wishing to travel;

Obtain the number of vehicles and/or vehicle type required;

Obtain the pick up day or date;

Obtain the pick up time;

Obtain the destination address;

Respond to confirmation or correction information (Yes or No). The caller is prompted to confirm what the system has heard. The caller confirms the booking with a “yes” is all the information is correct.

Still more complex call flows are possible. For example, a facility may be provided where a caller can be offered the opportunity to simply correct any one of the incorrect pieces of information or may start again to re-enter all the relevant information. Other refinements include placing one or multiple bookings per call or the addition or removal of the number of passengers or car types.

Of course, the booking is not be placed with the dispatch system if there is silence or the caller has hung up the phone and further, all or part of the call may be recorded for future analysis.

In a further modification, the Taxi Ordering System can include recording information for accepting bookings for different types of bookings used in the taxi industry such as parcels, wheelchairs, child/infant seats and pet requirements.

Upon receiving a valid order, the Taxi Ordering System 10 of FIG. 1, sends a message to the host database and dispatch system to book the taxi. If the host database and dispatch system accepts the booking, a prompt indicating the taxi has been ordered is played to the caller, the booking number given and the call will be terminated. If the host database and dispatch system does not accept the booking, the Taxi Ordering System transfers the caller to the operator queue on the PABX with the CLI and called number. A booking reference number can be read to the caller on a successful booking.

Alternative non “Ready Now” Bookings

If the caller says, “No” or remains silent to the pickup address information, additional details are requested from the caller. These can include the number of passengers and Car Types.

The Taxi Ordering System typically accepts between one (1) and eleven (11) passengers and the car types. The following car types and preferably available: 4 Seater Sedan/Taxi, 4 Seater Station Wagon/Taxi, 5 Seater/Taxi, 7 Seater Van/Taxi, 10 Seater Van/Taxi, 11 Seater Van/Taxi and Wheelchair Taxi.

The Taxi Ordering System accepts the number of cars and/or car type as well as the number of passengers, if the car type can take the number of passengers provided. If the caller provides the number of passengers, but does not provide the number of cars and/or car type, the Taxi Ordering System can default to the vehicle set out in the table above. For example, if there number of passengers is five (5), the Taxi Ordering System can automatically books a 5-seater car. If the number of passengers is between six (6) and ten (10), the Taxi Ordering System can asks the caller whether they want 2 cars or a van. If two cars are to be sent instead of one van, the prompt indicates that the customer accepts the costs for two cars. If the number of passengers is eleven (11), the Taxi Ordering System automatically books an 11-seater van. Simple changes to the system can be made, such as the addition or removal or car types, by changing the call flow and grammars.

Examples of days that can be accepted as “pick-up” days can include the following: Today, Tomorrow, Monday, Tuesday, Wednesday, Thursday, Friday, Saturday, Sunday, “next” Thursday, Thursday “week”, Christmas Day, Boxing Day, New Year's eve.

The Taxi Ordering System can ideally accept the following dates. It should be noted that the date should be provided before the month: e.g. 1 January, 2 January . . . 30 December, 31 December, First of January, Second of January . . . Thirtieth of December, thirty-first of December.

The Taxi Ordering System can ideally accept pick up times in five minute increments, other times can include: at midday, at midday today, at midnight, at midnight tonight, at 2 tomorrow afternoon, etc. If the time is ambiguous, e.g. the caller says “at 2 tomorrow”, the system can request an “am” or “pm” clarification.

The Taxi Ordering System reads back the details as understood to be provided by the caller. If the caller says “no” to the read-back address details, they are transferred to the operator queue on the PABX with the CLI and called number. Alternatively, the caller is allowed to change one (1) item at this point. If the caller attempts to change a second item, they are transferred to the operator queue on the PABX with the CLI and called number.

The caller is informed that they may use expressions such as “operator” at any time during the call. When the Taxi Ordering System recognises these expressions, a prompt is played advising the caller they are being transferred to an operator. The call with the CLI and called number, is then transferred to the operator or supervisor queue on the PABX.

When the Taxi Ordering System decides to transfer a caller, the system plays a prompt advising the caller they are to be transferred to an operator and then transfers the call, with the CLI and called number, to the operator queue on the PABX. Involuntary transfers may occur when:

There is no CLI and call number identification is not available;

There is no template;

The template is set to “Never IVR”;

The call is a ring-back after a predetermined number of minutes;

On the third error being any combination of the following,

The Taxi Ordering System is not able to understand the caller;

The Taxi Ordering System does not hear the caller;

The caller has some “Repeat”;

The caller has said “No” with a correction during Booking Callback.

As part of the reporting facilities, data such as transaction logs can be stored during operation. This data can be later processed so as to produce various transaction reports. Informative reports can include reports with the number of calls answered by the Taxi Ordering System with a breakdown of the number of calls processed into bookings or transferred to the operator queue on the PABX/PSTN switch can also be provided as part of the reporting module 35 or FIG. 2. A report with the call breakdown of the call content and transfer reasons can also be provided. The reporting will typically include: total number of calls, number of automated bookings made, calls with no CLI, calls with no database template, Ringbacks which are callers ringing back after a booking has already been made within a specified time limit window, typically 30 minutes, transfer to operators, recognition error transfers, maximum number of ports used, abandoned calls, detailed call number information (either CLI or obtained from the caller using NLSR), and duration of calls. Further, all errors can recorded and analysed for determination of necessary minor adjustments of the system.

Of course, the system can be open to many refinements. For example, many localised refinements can be made to possible major local destinations which can be process using NLSR to recognise the local destination.

The foregoing describes only preferred features of the present invention. Modifications, obvious to those skilled in the art can be made thereto without departing from the scope of the invention.

We claim:

1. A system interconnected with the public switched telephone network for providing for the ordering of taxis using natural language voice recognition, the system comprising:
a database of correlation data correlating a telephone identification number with an address;
caller identification system for identifying the telephone number associated with a caller;
a voice prompting unit for prompting a caller with the address registered in said database associated with the telephone number of the caller and whether the caller requires an immediate taxi service;
a voice recognition unit for recognising if the caller wishes an immediate taxi service at said address;
communications unit interconnected to a dispatch unit for dispatching taxi requests wherein said voice recognition unit determines that a caller wishes an immediate taxi at said address.

2. A system as claimed in claim 1 wherein said caller identification system includes a call line identifier that determines a call line associated with said caller.

3. A system as claimed in claim 1 wherein said call line identification system comprises a voice recognition system for recognising a telephone number read to it by a caller.

4. A system as claimed in claim 1 further comprising:
address recording means for recording the address associated with a caller telephone number for storage in the database for use with subsequent service request.

5. A system as claimed in claim 4 wherein said address recording means comprises a human operator.

6. A system as claimed in claim 1 wherein said system further comprises:
transfer means for transferring calls to one of a series of human operators upon predetermined conditions occurring in the interactions of said system with a caller

7. A method of utilising natural language speech recognition to dispatch a taxi to an address, the method comprising:
(a) initially creating a database of correlations between caller telephone numbers and caller addresses;
(b) determining a caller's telephone number upon calling;
(c) retrieving a corresponding caller's address from the database for the caller's telephone number;
(d) utilising a text to speech system or a prerecorded prompting system to convert the caller's address to a corresponding audio address;
(e) reading said address back to the caller in addition to a confirmation request and a ready now request;
(f) determining if the caller confirms the confirmation request and ready now request;
(g) upon detecting a confirmation by the caller, dispatching a taxi service to said caller address.

8. A method of enhancing the capability of a natural language speech recognition to dispatch a taxi to caller's addresses, the method comprising the step of:
(a) initially creating a database of correlations between caller telephone numbers and caller addresses;
(b) determining a caller's telephone number upon calling;
(c) determining if a caller's telephone number is within said database;
(d) if said caller's telephone number does not exist in said database:
(i) interrogating said caller for a caller address associated with said caller's telephone number;
(ii) recording a correlation in said database between said caller telephone number and caller address for future use.

9. A method as claimed in claim 8 wherein said step of interrogating the caller is undertaken by a human operator.

10. A method of introducing voice recognition into a public switched telephone network taxi ordering system, the method comprising the steps of:
(a) introducing an initial system which provides for immediate address recognition upon call line identification and a system voice proposal to deliver a taxi at a corresponding address upon call line identification;
(b) introducing a subsequent system including voice interrogation of taxi requirements of callers.

11. A method as claimed in claim 10 wherein said system looks up a database based on call line identification, extracts a taxi delivery address, asks the caller whether the taxi delivery address is correct and whether the caller is ready now and dispatches a taxi upon receiving a readiness and address confirmation.

12. A method as claimed in claim 10 wherein the system introduced in accordance with said step (b) includes a voice recognition of a caller's telephone number.

13. A method as claimed in claim 10 wherein the system introduced in accordance with said step (b) includes catering for at least one of differing taxi types, number of people, number of vehicles, pickup day, pickup time and destination address.
